(19) United States
(12) Patent Application Publication
(10) Pub. No.: US 2014/0127986 A1
(43) Pub. Date: May 8, 2014

(54) Cleaning device

(71) Applicant: William Cady, Seadrift, TX (US)

(72) Inventor: William Cady, Seadrift, TX (US)

(21) Appl. No.: 13/613,232

(22) Filed: Nov. 8, 2012

(51) Int. Cl. A22B 5/00

(52) U.S. Cl. CPC A22B 5/0082
USPC 452/173

(57) ABSTRACT

A cleaning device which uses water pressure and a cyclone like motion to clean and prepare fish and wild game for human consumption.

### CROSS-REFERENCE TORELATION APPLICATIONS

Non Applicable

### STATEMENT REGARDING FEDERALLY SPONSERED RESEARCH OR DEVELOPMENT

Non Applicable

### REFERENCE TO SEQUENCE LISTING, A TABLE, OR A COMPUTER PROGRAM LISTING COMPACT DISK APPENDIX

Non Applicable

### BACKGROUND OF THE INVENTION

The present invention is in the technical field of cleaning devices. More particularly, the present invention is in the technical field of cleaning devices for fish and wild game. More particularly, the present invention is in the technical field of portable cleaning devices for fish and wild game. Conventional cleaning devices for fish and wild game usually involve a sturdy and secure structure nearby or easily located to a water supply. Furthermore, it is difficult to properly and easily cleanse the fish of all scales and to remove all debris, (such as fur, feathers, blood etc.) left behind while cleaning wild game.

### SUMMARY OF INVENTION

The present invention is a cleansing device for users to easily clean away any unwanted items that may remain on their fish or wild game while preparing them for human consumption.

### BRIEF DESCRIPTION OF THE DRAWINGS

FIG. 1 is a perspective overview of the cleaning device of the present invention

### DETAILED DESCRIPTION OF THE INVENTION

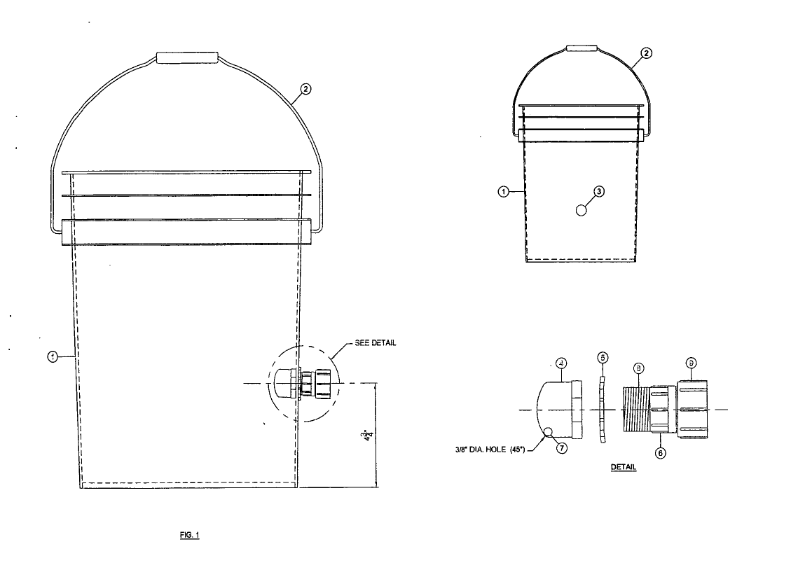

Referring now to the invention in more detail, in FIG. 1 there is shown a five (5) gallon plastic bucket 10 without lid or any type of top covering, which can be sat upright on a flat surface.

In detail, still referring to the invention in FIG. 1, the bucket 10 shown includes a ¾ inch hole 16 cut into side of bucket 10 4¾ inches from the bottom. Upon 16 a ¾ inch PVC cap 22 is placed inside 10, therein ⅜ inch 14 is cut at a 45 degree angle facing a 45 degree angle.

The construction details of the invention as shown in FIG. 1 are that the bucket 10 may be made of sturdy plastic, wood, metal, and the like. Further, the various components of the bucket 10 can be made of different materials.

In more detail, on the outside of 10, a ¾ inch Conduit steel locknut 18 is placed, allowing a ¾ inch orbit pvc swivel adapter 12 to attach with an average store bought garden hose 20. Forcing the water into the bucket 10 and as the pressure grows a small cyclone like force pushes the unwanted debris from the fish and game forcing it upwards and over the top of the bucket 10.

The construction details of the invention as shown in FIG. 1 are that the PVC threaded swivel 12, the ¾ inch PVC cap 22, and the ¾ inch conduit steel locknut may be made of sturdy plastic, wood, metal, and the like. Further, the various components of the 12, 22, and 18 can be made of different materials.

The advantages of the present invention include, without limitation, that it is sufficient in easily purging the scales, fur, feathers, blood, etc. from any fish or wild game that is being prepared for human consumption.

Further, it is portable, lightweight and quickly moved from one location to another to allow hunters and fisherman to fully enjoy and easily use. In broad embodiment, the present invention is a fish and game cleaning device.

While the previous written description of the invention allows one of ordinary skill to make and use what is considered presently to be the best mode thereof, those of ordinary skill will understand and appreciate the existence of variation, combinations, and equivalents of the specific embodiment, method and examples herein. The invention should therefore not be limited by the above described embodiment, method and examples, but y all embodiments and methods within the scope and spirit of the invention as claimed.

The embodiments of invention in which an exclusive property or privilege is claimed are defined as follows:

1. A fish and wild game cleaning device comprising of a ¾ inch swivel adapter wherein a conduit steel locknut is threaded through said ¾ inch swivel adapter with steel conduit locknut being pressed tightly against the 5 gallon bucket and the afore mentioned ¾ inch swivel adapter being inserted through a ¾ inch hole which is measured 4¾ % inches from the bottom of the bucket, allowing ¾ inch swivel adapter to connect within the bucket to a ¾ inch pvc cap with said cap having a ⅜ inch hole cut into the top at a 45 degree angle, placing the previously mentioned cap at such a position that said ⅜ inch hole is placed at a 45 degree angle towards the bottom of the bucket, whereas when water is applied through the use of average garden hose it will create a cyclone effect purging blood, debris, dirt and feathers from fish or wild game when freshly caught fish or wild game, cleaned, filleted, or skinned are placed inside said bucket, forcing the blood, debris, dirt and feathers away from the meat and out of the top of the bucket, therein cleaning the meat of all residue and helping to prepare it for human consumption.
The invention of claim 1 wherein said 5 gallon bucket can be altered or changed to a 2 gallon bucket.
The invention of claim 2 wherein said bucket with small holes placed directly across from each other in a vertical position positioning on either and both sides can be altered with an attachment of wire or metal to form a handle to carry and easily make portable said bucket.
The invention of claim 3 wherein said handle can be coated with plastic or rubber grips for better comfort in carrying said bucket.
The invention in claim 1 wherein the said ¾ inch swivel adapter can be made to slightly altered various sizes.
The invention in claim 3 wherein said ¾ inch swivel adapter is made of plastic, rubber, wood, or metal.
The invention of claim 1 wherein the said ¾ PVC cap is made of metal or plastic.
The invention of claim 1 wherein the said conduit steel locknut is made of varied materials such as plastic or metal.
The invention of claim 1 wherein a ¾ inch swivel adapter wherein the conduit steel locknut is placed through said ¾ inch swivel adapter with steel conduit locknut being pressed tightly against the afore mentioned ¾ inch swivel adapter being inserted through ¾ inch hole within a water holding device, allowing it to connect said swivel adapter within the bucket to the ¾ inch pvc cap, with said cap having a ⅜ inch hole cut into the top at a 45 degree angle, placing the previously mentioned cap at such a position that said ⅜ in hole is placed at a 45 degree angle towards the bottom of said water holding device.
